(19) United States
(12) Patent Application Publication
(10) Pub. No.: US 2026/0091388 A1
(43) Pub. Date: Apr. 2, 2026

(54) Pressure Supply Unit and Method for Providing a First Target Pressure Level and a Second Target Pressure Level for a Microfluidic Analysis System, Microfluidic Analysis System

(71) Applicant: Robert Bosch GmbH, Stuttgart (DE)

(72) Inventor: Ronny Leonhardt, Gerlingen (DE)

(21) Appl. No.: 19/113,158

(22) PCT Filed: Aug. 31, 2023
(86) PCT No.: PCT/EP2023/073863

§ 371 Date: Mar. 19, 2025

(30) Foreign Application Priority Data
Sep. 23, 2022 (DE) 10 2022 210 044.1

(51) Int. Cl. B01L 3/00

(52) U.S. Cl. CPC B01L 3/50273; B01L 2200/146; B01L 2300/14; B01L 2400/0622

(57) ABSTRACT

A pressure supply unit for providing a first target pressure level and a second target pressure level, includes a pump for drawing in a fluid, a first fluid flow control component, and a second fluid flow control component. The first fluid flow control component is arranged on a first side of the pump that controls the fluid flow according to a first current pressure level and is thus configured to provide the first target pressure level on the first side of the pressure supply unit. The second fluid flow control component is arranged on a second side of the pump that controls the fluid flow according to a second current pressure level and is this configured to provide the second target pressure level on the second side of the pressure supply unit.

### PRIOR ART

DE 10 2018 114 150 A1 discloses an apparatus and a method for separating a fluidic sample, wherein the sample separation apparatus has only one pump for moving the respective mobile phase for all separation stages. In view of this implementation of only a single high-pressure pump as the fluid drive, the first-dimensional analysis and the second-dimensional analysis are not carried out in parallel, but one after the other.

### CORE AND ADVANTAGES OF THE INVENTION

The invention relates to a pressure supply unit for providing a first target pressure level and a second target pressure level, a method for providing a first target pressure level and a second target pressure level, a microfluidic analysis system, and a control unit that controls the aforementioned method, and finally a corresponding computer program according to the main claims.

An advantage of the invention with the features of the independent patent claims is that a compact pressure supply unit with a simplified structure and simplified control for providing two different target pressure levels, i.e. specific or determined pressure levels, is provided, which can also be manufactured in a cost-effective manner.

This is achieved with a pressure supply unit according to claim 1 for providing a first target pressure level and a second target pressure level, wherein the first target pressure level and the second target pressure level differ from one another. The pressure supply unit comprises
a pump for drawing in a fluid, in particular a gas such as air
a first fluid flow control component, which
   is arranged on a first side of the pump, and
   for enabling a fluid flow
      from the first side of the pressure supply unit to the pump, provided that a first current pressure level on the first side is greater than the first target pressure level, and
      from the surrounding area of the pressure supply unit to the pump, provided that the first current pressure level on the first side is lower than the first target pressure level or equal to the first target pressure level,
         and is thus configured to provide the first target pressure level on the first side of the pressure supply unit, as well as
a second fluid flow control component, which
   is arranged on a second side of the pump, and
   for enabling fluid flow
      from the pump to the second side of the pressure supply unit, provided that a second current pressure level on the second side is lower than the second target pressure level, and
      from the pump to the surrounding area of the pressure supply unit, provided that a second current pressure level on the second side is greater than or equal to the second target pressure level,
         and is thus configured to provide the second target pressure level on the second side of the pressure supply unit.

Pressure supply units are configured to generate pressure levels and supply other systems that are or can be connected to the pressure supply unit with fluid, in particular with compressed air. The pressure supply unit according to claim 1 is configured to supply other systems with a fluid which has a certain pressure (for example compressed air), i.e. for example with a high pressure level, in particular up to 3000 mbarA, and/or a vacuum pressure level, in particular up to 200 mbarA. The pressure supply unit can be or can be connected to other systems via at least one pneumatic interface, for example.

The term “target pressure level” refers in particular to a target pressure value, such as 400 mbarA (millibar) or 2600 mbarA, with a tolerance range around this target pressure value, such as +/−100 mbar, wherein 1 bar=105 Pa. The target pressure levels are the pressure levels that can be provided by the pressure supply unit for a consumer/system. For example: the first target pressure level corresponds to 400 mbarA+/−100 mbar and the second target pressure level corresponds to 2500 mbarA+/−100 mbar.

The term “current pressure level” refers to a current pressure value, such as 2300 mbarA. The current pressure levels are adjusted using the pump and the fluid flow control components until they correspond to the respective target pressure levels, i.e. in particular, they are within the tolerance range around the target pressure values.

The pressure supply unit is arranged in the surrounding area in which a fluid, in particular a liquid or a gas, such as air, may be present. The surrounding area is characterized by the fact that it is filled with a fluid or can be filled with one. The surrounding area may, in particular, include everything around the pressure supply unit and may be configured as an open volume or a limited volume such as a room, a housing, a tank, a fluid tank, etc.

The pump for drawing in the fluid, in particular a gas and/or a liquid, can be configured, for example, as a single pump, for example as a double-head pump. In particular, the pump may comprise a diaphragm pump, a blower or a compressor. The pump is designed to deliver the fluid. The pump connects reservoirs, i.e. tanks or areas for receiving the fluid, with one other and can transfer the fluid between the reservoirs, i.e. in particular, it can draw in the fluid out of one reservoir and transfer it to another reservoir. For example, the pump can draw in the fluid from the surrounding area of the pressure supply unit and transfer it to a system, such as a pressure tank, a microfluidic analysis system for performing a sample analysis, in particular the test module units of the analysis system, etc., where the fluid is needed.

The transfer is carried out in particular by the fluid flow control components, in particular valves, such as check valves or switching valves, such as 3/2-way valves. In particular, fluid flow control is understood to mean both blocking/obstructing a fluid flow and mixing fluid streams, as well as redirecting or diverting the fluid flow.

The pump is disposed between two sides of the pressure supply unit, the first side and the second side. The sides indicate, in particular, areas in which different pressure levels can be set. For example, tanks, such as hydraulic tanks or pressure tanks, may be arranged on the different sides, in each of which a pressure corresponding to the respective target pressure level can be generated. Furthermore, fluid flow control components are disposed on the sides, along with lines that connect the different units and components and through which the fluid can move between the different units and components. Each side may, for example, be connected by means of an interface or a connection for fluid transfer to a system or subsystem, in particular a test module of a microfluidic analysis unit, and provide a pressure level for it by transferring the fluid of the respective side, i.e. for example, by supplying compressed air to the system at a target pressure level set by the pressure supply unit.

One advantage is that a compact pressure supply unit can be realized by designing the supply circuit so that both target pressure levels can be generated with a single pump and made available to a system connected to the pressure supply unit. Furthermore, a pump can thus advantageously be eliminated in the overall pressure generation system, which, in addition to installation space, above all allows costs to be reduced, along with the complexity of the control with regard to parallel control methods. Another positive effect is that the number of potential noise sources (pumps) is reduced, making the system quieter and therefore more user-friendly.

In one embodiment, the first fluid flow control component can be connected to a first storage volume, in particular a first fluid tank, in particular a gas tank, and/or the second fluid flow control component can be connected to a second storage volume, in particular a second fluid tank, in particular a gas tank. One advantage of this is that pressure can be stored in the tanks/volumes on either side of the pressure supply unit and made available to the system.

Another advantage is that this can increase the elasticity of the system and absorb pressure peaks that may occur due to possible switching of flow control components for (in particular valves), due to the start-up of the pump or design-related pulsations of the pump. If it is desired only that the volumes provide an absorbing effect, it is recommended to select a volume of 5-10 percent of the volume flow at the design operating point. If the storage function is also to be addressed with the pressure supply unit, which is particularly important in a shutdown operation, the volume must be designed in accordance with the components installed in the system and should be designed so that the system components can be supplied from the tanks for their function for 30 to 120 seconds if the pump is not in operation.

In one embodiment, the first side is designed as a low-pressure area and the second side as a high-pressure area, wherein a low-pressure level can be provided as a first target pressure level in the low-pressure area, and wherein a high-pressure level can be provided as a second target pressure level in the high-pressure area. A system connected to this pressure supply unit can thus be advantageously supplied with a low pressure level and a high pressure level, wherein only one pump is used instead of two.

In one embodiment, the first target pressure level and the second target pressure level each have a target pressure value of 400 mbarA, 2500 mbarA or a target pressure value in the range of 400 mbarA and 2500 mbarA system pressure, as well as a tolerance range around the respective target pressure value, in particular +/−100 mbar, wherein the first target pressure level and the second target pressure level differ from one another, i.e. in particular such that the respective target pressure values of the target pressure levels differ from one another.

In one embodiment, at least one pressure sensor unit for pressure control and/or for controlling a safety shutdown is arranged on the first side and/or the second side. In particular, it can be used to measure the current pressure levels. Furthermore, this makes it possible to monitor the pump, as well as to operate it intermittently in order to reduce the pump running time and thus in particular to minimize noise. The pressure sensor unit can be used to implement safety shutdowns, as well as to carry out simple pressure control and a shutdown operation of the pressure supply unit. The pressure sensor unit may, for example, comprise a MEMS pressure sensor.

In one embodiment, the first fluid flow control component and the second fluid flow control component are dimensioned in such a way that a pressure loss across these components is less than or equal to 5% of the system pressure (the system pressure here corresponds to the ambient pressure, i.e. the pressure of the surrounding area), since otherwise the hystereses are too dependent on the system. In general, the pressure loss should be very small. In pneumatic systems, the pressure losses tend to be very small compared to hydraulic systems. The aim is to keep the pressure loss across the valves low compared to the working pressure, so as not to limit the efficiency of the pump too greatly. In this case, it should not exceed 5 percent of the system pressure and should be selected so that it is as low as possible. One advantage is that the efficiency and reliability of the pressure supply unit can be thereby increased.

According to one embodiment, the first fluid flow control component and/or the second fluid flow control component comprise a switching valve, in particular a 3/2-way valve. One advantage is that the target pressure levels can be variably set on the sides with the switching valve, thus making the pressure supply unit flexible and adaptable to the needs of the connected or connectable system/consumer.

In one embodiment, the first fluid flow control component and/or the second fluid flow control component comprise a check valve. The target pressure level in the respective circuit (i.e. on the respective side) is set here via the opening pressure of the spring of the corresponding check valve. Instead of switching valves, passive check valves are used here for both components, for example, with springs dimensioned so that they:
open on the first side (here: low pressure or vacuum side) when the vacuum pressure (first current pressure level) falls below a critical pressure value, for example 400 mbarA (in this context, “opening” means that the fluid on the first side can flow from the surrounding area into the pressure supply unit);
open on the second side (here: high pressure side) if the high pressure (second current pressure level) is above a critical pressure value, for example 2500 mbarA (opening means that the fluid on the second side can escape into the surrounding area).

One advantage is that a very simple pressure supply unit can be constructed, which enables further reductions in cost and complexity. In particular, such an embodiment can be selected if the first and second target pressure levels are fixed and should not be variably adjustable, corresponding to a fixed operating point. Check valves are a good way of setting and defining a fixed pressure range in the hardware, which is a robust solution and provides a very good level of control.

Advantages of a method for providing a first target pressure level and a second target pressure level, in particular using one of the above-mentioned pressure supply units, wherein the first target pressure level and the second target pressure level differ from one another, comprising the following method steps:
providing the first target pressure level on the first side of the pressure supply unit by enabling a fluid flow
   from the first side of the pressure supply unit to the pump, provided that a first current pressure level on the first side is greater than the first target pressure level, and
   from the surrounding area of the pressure supply unit to the pump, provided that the first current pressure level on the first side is lower than the first target pressure level or equal to the first target pressure level,
providing the second target pressure level on the second side of the pressure supply unit by transferring the fluid
   from the pump to the second side of the pressure supply unit, provided that a second current pressure level on the second side is lower than the second target pressure level, and
   from the pump to the surrounding area of the pressure supply unit, provided that a second current pressure level on the second side is greater than or equal to the second target pressure level,
      arise directly from the advantages mentioned for the pressure supply unit. In particular, it is advantageous that two different target pressure levels can be provided for a system/consumer by means of a pump, in particular a single pump, by controlling the fluid flow depending on the current pressure level, i.e. in other words, that the fluid flows either between the two sides of the pressure supply unit or between the surrounding area and one side at a time, depending on the current pressure levels, and thus that the target pressure levels can be set on the two sides without having to use another pump. The redirection/diversion of the fluid flow, depending on the respective current pressure level, is achieved in particular by means of the fluid flow control components, which are connected to the pump by fluid lines (also called fluid channels) into which the fluid can flow, the surrounding area and interfaces for connecting a consumer (e.g. a system or subsystem, a microfluidic analysis system or a test module unit of a microfluidic analysis system, etc.). Another advantage is that the pump does not have to be operated in the state where the pressures upstream and downstream of the pump are in the target pressure range, and may, for example, only operate on an as-needed basis. As-needed in this case means when at least one of the target pressures is not within the limit.

For example, this method can be implemented in software or hardware, or in a mixed form of software and hardware, for example in a control unit.

In one embodiment, when the first target pressure level is reached on the first side and the second target pressure level is reached on the second side, the pump of the pressure supply unit is switched off (=shutdown operation of the pressure supply unit) or the pump continues to be operated (=continuous operation of the pressure supply unit), wherein, in the case of continued operation, the fluid is drawn in from the surrounding area and transferred to the surrounding area by means of the pump. Continuous operation is particularly useful when the proportion of this operating phase is very short compared to the other three operating modes (=generating high pressure, generating low pressure, generating high and low pressure), for example when the proportion of time is less than 10 percent (t<10 percent). Otherwise, it may be more efficient to operate the pump in shutdown mode.

The microfluidic analysis system may comprise a pressure supply unit according to one of the previously mentioned embodiments or may be connected to such a unit, in particular by connecting the fluid channels of the pressure supply unit to fluid channels of the test module unit via interfaces, in particular pneumatic interfaces. When connected, the test module unit is supplied with the first target pressure level and the second target pressure level, which can be provided by the pressure supply unit at the connections/(pneumatic) interfaces of the pressure supply unit.

Advantages of a microfluidic analysis system for performing a sample analysis, comprising a test module unit for sample collection for a molecular diagnostic analysis, comprising
a pressure supply unit according to one of the embodiments described above for providing the first target pressure level and the second target pressure level,
peripheral components for performing a molecular diagnostic analysis and
microfluidic elements for sample transport in the test module unit,
   wherein the microfluidic elements of the test module unit are controllable by means of the first target pressure level and/or the second target pressure level, and
   wherein the pressure supply unit is or can be connected to the test module unit via an interface.

result from the pressure supply unit described above.

A microfluidic analysis system is a small pneumatic device, in particular a medical device.

An example of a microfluidic analysis system is the Vivalytic® platform (Robert Bosch GmbH), which represents a universal diagnostic platform that can be used to perform various single or multiplex tests in a cartridge.

In microfluidic analysis systems for conducting sample analysis, the sample material, such as a smear, blood, urine, etc., is first treated with ultrasound. In this way, the cell membrane is opened and the DNA and RNA molecules are released. They are filtered, multiplied and detected in the next step. Even the smallest amounts of DNA and RNA can be detected in the sample material.

The microfluidic analysis system includes at least one test module unit, which includes all the necessary peripheral components to perform a molecular diagnostic analysis. Such peripheral components may include, for example, the following components: Heating elements, a cartridge insertion mechanism, a pneumatic manifold for distributing and controlling valves, a clamping device for the cartridge and a pressure tank (i.e. a pneumatic tank) to store a minimum amount of compressed air as a reservoir and/or an optical unit to verify the fluidic reaction results inside the cartridge. The optical unit can be used for sample analysis, such as fluorescence measurements on the sample, wherein, in particular they may comprise an optical sensor unit and an illumination source.

The test module is supplied with pressure (i.e. the first target pressure level and the second target pressure level) and usually does not include an internal way to generate pressure, but rather only connections/interfaces through which the pressurized fluid, for example compressed air, can be supplied by the pressure supply unit. Alternatively, the pressure supply unit may be integrated into the test module, i.e. in particular, such that these are then fixedly connected to each other.

The term “sample transport” can be understood to mean, in particular, the movement of the sample, in particular a sample liquid, in the test module unit. In other words, sample transport is primarily the transportation of fluids.

Sample collection is carried out by the test module unit by inserting a cartridge into the test module unit, wherein the sample is first placed into the cartridge. In the test module unit, a partially or fully automated processing of the sample takes place within the cartridge, for example for an analysis of the sample, in particular to perform diagnostic tests. The sample is, is in particular, a sample liquid.

The microfluidic elements may be, in particular, microfluidic valves and (pump) chambers. At least two pressure levels, in this case the target pressure levels, are used to activate the microfluidic elements. In particular, the activation and provision of the target pressure levels by the pressure supply unit, which has a pneumatic interface to the test module unit.

The test module unit may, for example, comprise one or more test modules that are supplied with the first and second target pressure levels by the pressure supply unit. For this purpose, the test module unit may be connected or connectable to a fluid line of the first and second side to the first and second side of the pressure supply unit, in particular via a connection or a pneumatic interface. The use of the pressure supply unit described above makes it possible to supply two different target pressure levels with just one pump, in particular a single pump.

In one embodiment, multiple test module units may be controlled in parallel by a common pressure supply unit according to any of the embodiments described above, thus enabling, for example, a rack solution for the microfluidic analysis system. This can then be supplied in its entirety or in several discrete units by means of corresponding pressure supplies.

For example, a vacuum pressure up to 200 mbarA is selected as the first target pressure level and pressures up to 3000 mbarA as the second target pressure level. In particular, the operating range is at target pressure levels of 400 mbarA and 2600 mbarA,

An example of a microfluidic analysis system that is supplied overall with both target pressure levels (i.e. both target pressure levels are provided to both test module units) is a microfluidic analysis system which diagnoses cartridges by activating the two target pressure levels on one respective valve for each cartridge to thereby move, direct, control and/or mix liquids on the cartridge. By using the pressure supply unit described above, it is possible to set both working pressures with just one pump and make them available to the cartridge.

The approach presented here also creates a control unit that is designed to control, activate or implement the steps of a variant of a method presented here in corresponding devices or units. This embodiment of the invention in the form of a control unit can also solve the problem underlying the invention quickly and efficiently. For this purpose, the control unit may have at least one computing unit for processing signals or data, at least one storage unit for storing signals or data, at least one interface to a sensor or an actuator for reading in sensor signals from the sensor or for outputting control signals to the actuator and/or at least one communication interface for reading in or outputting data. In this context, the term “control unit” can be understood to mean an electrical device that processes sensor signals and emits control signals and/or data signals as a function thereof.

A computer program product or computer program with program code, which can be stored on a machine-readable carrier or storage medium such as a semiconductor memory, a hard disk memory or an optical memory and is used to carry out, implement and/or control the steps of the method of one of the embodiments described above, is also advantageous, in particular if the program product or program is executed on a computer or a device.

### BRIEF DESCRIPTION OF THE DRAWINGS

Exemplary embodiments of the invention are illustrated in the drawings and explained in more detail in the following description. The same references in the figures denote the same or equivalent elements.

### Shown are

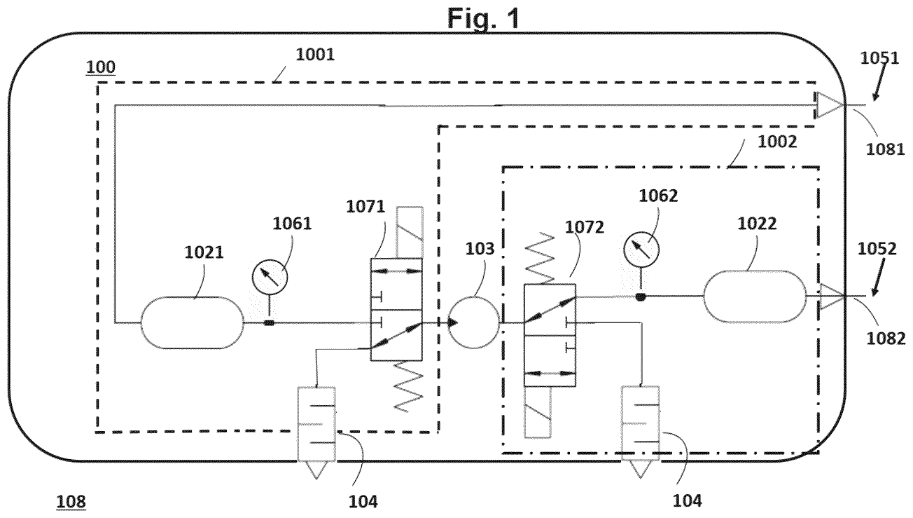

FIG. 1 a schematic structure of a pressure supply unit according to a first exemplary embodiment,

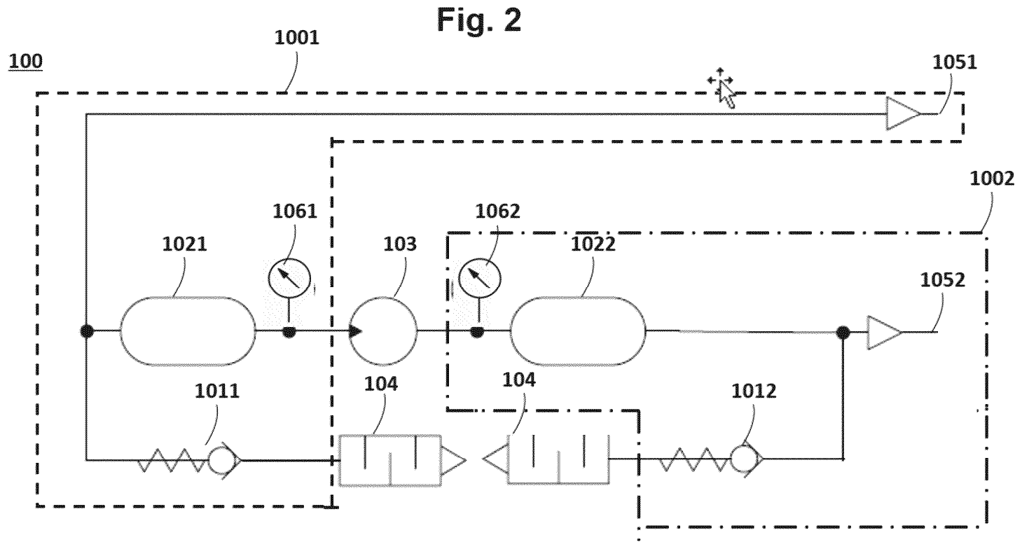

FIG. 2 a schematic structure of a pressure supply unit according to a second exemplary embodiment,

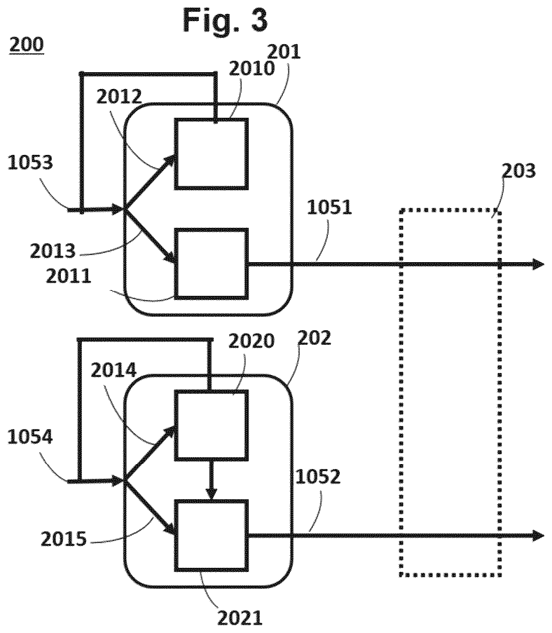

FIG. 3 a flow chart of a method for providing a first target pressure level and a second target pressure level,

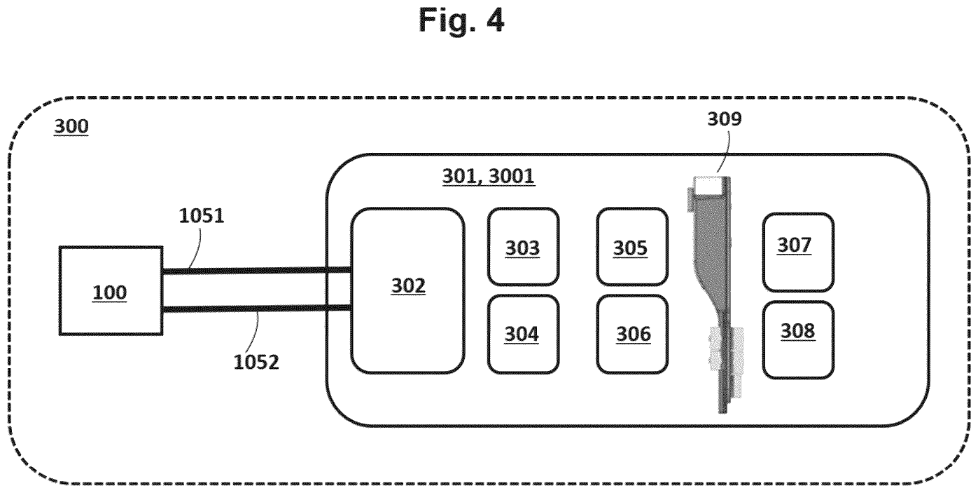

FIG. 4 a schematic sketch of a microfluidic analysis system according to a third exemplary embodiment,

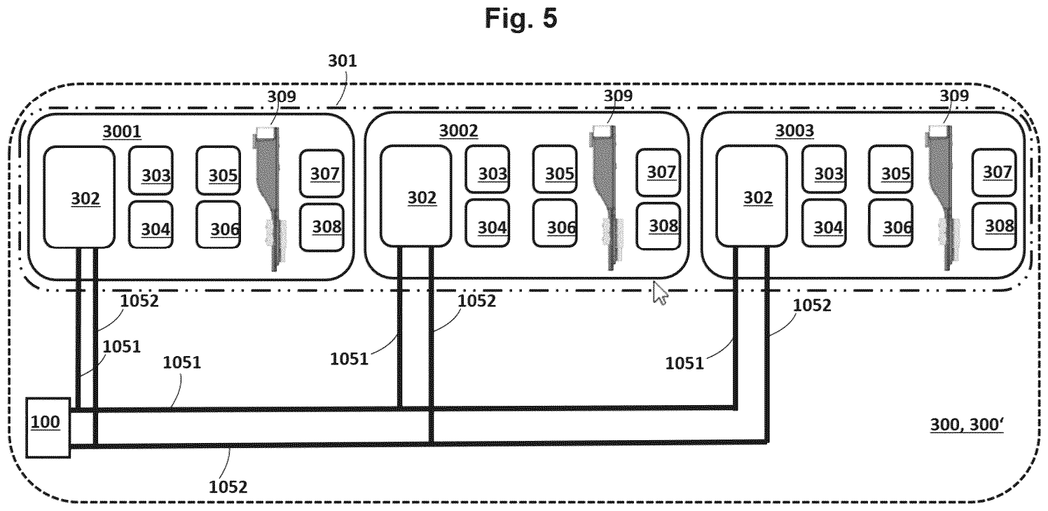

FIG. 5 a schematic sketch of a microfluidic analysis system according to a fourth exemplary embodiment, and

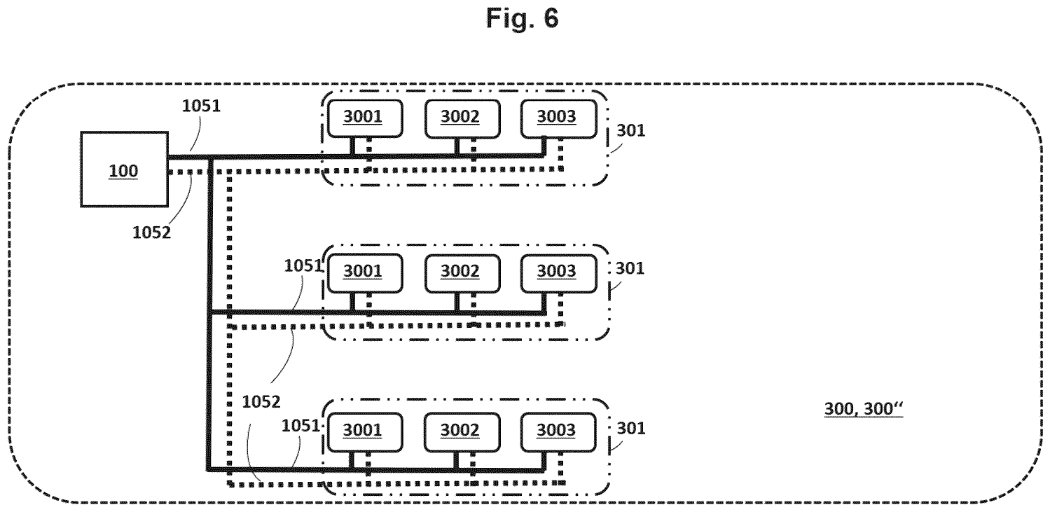

FIG. 6 a schematic sketch of a microfluidic analysis system according to a fifth exemplary embodiment.

### EXEMPLARY EMBODIMENTS OF THE INVENTION

FIG. 1 shows a schematic structure of a pressure supply unit 100 according to one exemplary embodiment, in particular a basic connection option of a single-circuit system solution. The pressure supply unit 100 comprises a pump 103, which is disposed between a first side 1001 and a second side 1002 of the pressure supply unit 100. A first fluid flow control component 1071 is disposed on the first side 1001 and a second fluid flow control component 1072 is disposed on the second side 1002, which are connected via fluid channels to the pump 103, the surrounding area 108 (or silencers 104) and a first pneumatic interface 1081, at which a first target pressure level 1051 can be provided and a second pneumatic interface 1082, at which a second target pressure level 1052 can be provided, or storage tanks 1021, 1022, which are arranged between the respective interfaces 1081, 1082 and the valves 1071, 1072. In FIG. 1, the first fluid flow control component 1071 is formed by an electrically actuated 3/2-way valve that is closed in the basic position and has a built-in mechanical spring for resetting. The second fluid flow control component 1072 is formed in FIG. 1 by an electrically actuated 3/2-way valve that is open in the basic position and has a built-in mechanical spring for resetting. The two 3/2-way valves are configured to alternately connect the pump 103 via silencers 104 to the surrounding area 108 of the pressure supply unit 100 and to pneumatic interfaces (connections 1081, 1082), at which the target pressure levels 1051, 1052 are provided, wherein a system, in particular a microfluidic analysis system, is connected or connectable to the pressure supply unit 100 via the pneumatic interfaces 1081, 1082. The first connection 1081 can be used to supply the system with the first target pressure level 1051, and the second connection 1082 can be used to supply the system with the second target pressure level 1052.

For example, the 103 pump may be configured as a diaphragm pump, which in most standard versions can be used for both vacuum and high pressure, as a blower or as a compressor. The pump 103 draws in a fluid, such as ambient air, via an upstream switching valve 1071, shown here as a 3/2-way model. In the illustration, ambient pressure is drawn-in during the de-energized-open operation, so that the pump 103 corresponds functionally to the standard operating mode. The drawn-in fluid is compressed and when the valve 1072, also a 3/2-way model here, is not controlled, pressure can be built up in the storage tank 1002 on the high-pressure side (corresponds to the second side 1002) and made available to the system, for example the microfluidic analysis system.

When both valves 1071, 1072 are energized, the pump 103 works as a standard vacuum pump by drawing fluid out of the system through the low-pressure connection 1081, thereby generating a vacuum pressure on the first side 1001 and releasing it into the surrounding area 108 (here, the connection to the surrounding area 108 is equipped with a silencer 104). A storage volume 1021, 1022 is provided on both sides of the pump 103 to increase the elasticity of the system and to absorb pressure peaks that may be caused by possible switching of the valves 1071, 1072, by the start-up of the pump 103 or by design-related pulsations of the pump. In this case, if only a pure absorbing effect is desired via the storage tanks 1021, 1022, it is recommended to select a volume of 5-10 percent of the volume flow at the design operating point.

If the storage function with the pressure supply unit 100 is also to be addressed, which is particularly important in a shutdown operation, the volume should be designed depending on the components installed in the system, for example a microfluidic analysis system connected to the pressure supply unit, and should be designed such that the system components can be supplied from the tanks 1021, 1022 for their function for 30-120 seconds if the pump 103 is not in operation. The pressure valves 1071, 1072 should generally be dimensioned in such a way that the pressure loss across valves 1071, 1072 is kept low compared to the working pressure, so as not to overly limit the efficiency of pump 103. In this case, it should not exceed 5 percent of the system pressure and should be selected so that it is as low as possible.

Pressure sensors 1062 and 1061 should be provided to monitor the pump, as well as to enable intermittent or shutdown operation to reduce the pump's operating time and thus minimize noise. This will allow safety shutdowns as well as simple pressure control. In FIG. 1, pressure sensor units 1061, 1062 are disposed on both sides 1001, 1002 between the valve 1071, 1072 and storage tank 1021, 1022 for monitoring the pressure, in particular for measuring the respective current pressure value.

The described operating mode of (standard) pressure or vacuum generation is possible with the constellation shown and essentially corresponds to a dual-circuit design (i.e. one pump 103 is used to provide each target pressure level, in particular one pump each, which in this case would correspond to two pumps, therefore a dual-circuit design), which essentially share one pump 103, in the form of an X-shape design. In this variant and operating mode, the power range of the pump 103 can be selected so that the pneumatic power corresponds to the maximum of both partial circles (i.e. the first side 1011 and the second side 1002) and the target pressure levels 1051, 1052, for example, operation between 200 mbarA and 3000 mbarA system pressure, can be met.

The suggested connection also allows the pump 103 to be operated in combination: If a pump with a sufficient performance range is selected, the pump can, with the appropriate valve setting (low-pressure valve 1071 energized; high-pressure valve 1072 de-energized), simultaneously generate low pressure as the first target pressure level 1051 and high pressure as the second target pressure level 1052 and supply it to the system, for example the microfluidic analysis system. If both current pressure ranges are not within the tolerance range around the target pressure value, i.e. they do not correspond to the respective target pressure level 1051, 1052, according to the control, for example target pressure +/−100 mbar, the pump draws in fluid from the low-pressure area, i.e. the first side 1001, causing it to be evacuated, and feeds the gas quantity directly into the high-pressure area, i.e. the second side 1002. Once the target pressure level is reached in one of the partial circuits, i.e. on one of the sides 1001, 1002, the corresponding valve 1071, 1072 on this side 1001, 1002 is switched to the surrounding area in order to draw in the pumped fluid from the surrounding area (vacuum side 1001) or discharge it into the surrounding area (high pressure side 1002) in order to remain within the control limits. If both target pressure levels 1051, 1052 are reached, the pump can be operated as a continuous pump when it is connected to the surrounding area both in the drawing-in and pressure area via valves 1071, 1072, i.e. it can be operated in so-called idle mode. This makes particular sense if the share of this operating phase is very small in comparison to the other three operating modes (t<10 percent). Alternatively, the pump can then be operated in shutdown operation. In this case, both pressure signals from the pressure sensor units 1061, 1062 should be included in the operating decision, since these are functionally linked by a logical OR operator. The following table shows the operating modes with the associated valve control states (0=de-energized; 1=energized):

| | | Energization | Energization |
|---|---|---|---|
| | | of low- | of high- |
| | | pressure | pressure |
| Phase | Description | valve 1071 | valve 1072 |
| 1 | Generating high pressure 1052 | 0 | 0 |
| 2 | Generating low pressure 1051 | 1 | 1 |
| 3 | Generating high pressure 1052 | 1 | 0 |
| | and low pressure 1051 | | |
| 4 | Idle | 0 | 1 |
| 1 | Generating high pressure 1052 | 0 | 0 |
| 2 | Generating low pressure 1051 | 1 | 1 |
| 3 | Generating high pressure 1052 | 1 | 0 |
| | and low pressure 1051 | | |
| 4 | Idle | 0 | 1 |

FIG. 2 shows a schematic structure of a pressure supply unit 100 according to one exemplary embodiment, which differs in particular from the exemplary embodiment shown in FIG. 1 in that check valves 1011, 1012 are used here instead of switching valves 1071, 1072 as components for controlling the fluid flow. This is a simplified design variant compared to the exemplary embodiment shown in FIG. 1, which enables further reductions in cost and complexity and can be used in particular when the working pressure level, i.e. the first target pressure level 1051 and the second target pressure level 1052, is fixedly defined and should not be variably adjustable.

The pressure supply unit 100 comprises a pump 103, which is disposed between the first side 1001 and the second side 1002 of the pressure supply unit 100. A first fluid flow control component 1071 is disposed on the first side 1001 and a second fluid flow control component 1072 is disposed on the second side 1002, which are connected via fluid channels to the pump 103, the surrounding area 108 (or silencers 104) and a first pneumatic interface 1081, at which a first target pressure level 1051 can be provided and a second pneumatic interface 1082, at which a second target pressure level 1052 can be provided, or storage tanks 1021, 1022, which are arranged between the respective interfaces 1081, 1082 and the valves 1071, 1072.

The target pressure level 1051, 1052 in the respective circuit, i.e. on the respective side 1001, 1002, is set in FIG. 2 via the opening pressure of the spring of the corresponding check valve 1011, 1012. Passive check valves 1011, 1012 are used here, whose springs are dimensioned so that they:
open on the vacuum side (here: first side 1001), if the current pressure level on the first side 1001 falls below a critical value (i.e. below the first target pressure level 1051, in particular the target pressure value minus the tolerance range), for example 300 mbar, and
open on the high-pressure side (here: second side 1002) if the current pressure level is above a critical value (i.e. above the second target pressure level, in particular the target pressure value plus the tolerance range), for example 2500 mbarA.

This design variant of a pressure supply can also be used in shutdown operation if pressure sensors 1061, 1062 are used that allow control. Otherwise, this design is preferred for the 103 continuous pump run. If the opening pressure of the check valves 1011, 1012 is known, the pressure monitoring (i.e. the pressure sensor units 1061, 1062 in FIG. 2, which are each arranged between the pump 103 and the storage tanks 1021, 1022) can be eliminated, making possible a further cost reduction. The pump 103 should then be operated continuously in order to maintain the target pressure levels 1051, 1052.

According to further exemplary embodiments, it is also possible to use a 3/2-way valve 1071 as the first component, wherein the first target pressure level 1051 is generated, as can be seen from the description of FIG. 1 and a check valve 1012 is to be used as the second component, wherein the second target pressure level 1052 is generated, as can be seen from the description for FIG. 2. Alternatively, a check valve 1011 can be used as the first component, wherein the first target pressure level 1051 is generated, as can be seen from the description of FIG. 2, and a 3/2-way valve 1072 can be used as the second component, in which case the second target pressure level 1052 is generated, as can be seen from the description of FIG. 1. This may be particularly advantageous if one of the target pressure levels is to be adjustable and the other is fixed.

FIG. 3 shows a flow chart of a method 200 for providing the first target pressure 1051 and the second target pressure level 1052, in particular using a pressure supply unit 100 according to one of the exemplary embodiments described above, wherein the first target pressure level 1051 and the second target pressure level 1052 differ from each other.

The first target pressure level 1051 is provided on the first side 1001, in particular at the first connection 1081 of the pressure supply unit 100, as follows: Depending on the first current pressure level 1053, a fluid flow is controlled as follows:
Lowering in 2010 the first current pressure level 1053 until the first target pressure level 1051 is reached: If the first current pressure level 1053 is greater 2012 than the first target pressure level 1051, the first component 1071, 1011 controls the fluid flow in such a way that the fluid, drawn-in by the pump 103 flows from the first connection 1081 to the pump 103. This causes the current pressure level 1053 at the first connection 1081 to drop until it reaches the first target pressure level 1051.
If the first target pressure level is reached 2011 or if the level falls below this level 1051: If the first current pressure level 1053 is lower than or equal to 2013 the first target pressure level 1051, the first component 1071, 1011 controls the fluid flow in such a way that the fluid flow from the first connection 1081 to the pump 103 is interrupted and, in particular, that the pump 103 is instead connected to the surrounding area 108 so that it draws in the fluid from the surrounding area 108.

The second target pressure level 1052 is provided on the second side 1002, in particular at the second connection 1082 of the pressure supply unit 100, as follows: Depending on the second current pressure level 1052, a fluid flow is controlled as follows:
increasing 2020 the second current pressure level 1054 until the second target pressure level 1052 is reached: If the second current pressure level 1054 on the second side 1002 is less 2014 than the second target pressure level 1052, the second fluid flow control component 1072, 1012 controls the fluid flow such that the fluid is directed from the pump 103 to the second connection 1082
If the second target pressure level is reached 2021 or if the level falls below this level 1052: If the current pressure level 1054 is greater than or equal to 2015 the second target pressure level 1052, the second fluid flow control component 1072, 1012 regulates the fluid flow in such a way that the fluid flow from the pump 103 to the second connection 1082 is interrupted and, in particular, that the pump 103 is instead connected to the surrounding area so that it transfers the fluid to the surrounding area.

Optionally, when the target pressure levels are reached 2011, 2021, instead of the continuous operation described above, in which the pump 103 draws in the fluid from the surrounding area 108 on the first side 1001 and delivers it to the surrounding area on the second side 1002, a shutdown operation 203 of the pressure supply unit can be used, in which the pump 103 switches off. In particular, monitoring of the current pressure levels by pressure sensor units 1061, 1062 is advantageous here, which, when at least one of the target pressure levels 1051, 1052 is no longer met, provide a control signal which is suitable for ending the shutdown operation 203 by switching on the pump 103 or which is suitable for issuing a warning message to a user or to the system connected to the pressure supply unit 100.

FIG. 4 shows a schematic representation of a microfluidic analysis system 300 for performing a sample analysis, comprising a test module unit 301 for collecting a sample for molecular diagnostic analysis, wherein the test module unit 301 in this exemplary embodiment comprises a test module 3001 comprising
a pressure supply unit 100, as shown for example in FIG. 1 or FIG. 2, for providing the first target pressure level 1051 and the second target pressure level 1052,
peripheral components 305, 306, 307, 308 for conducting a molecular diagnostic analysis and
microfluidic elements 302, 303, 304 for sample transport in the test module unit 3000.

In this exemplary embodiment, the peripheral components comprise an optical unit 305 that is configured, for example, to perform fluorescence measurements on the sample. The optical unit 305 can provide both illumination and optical excitation, as well as detection of an optical signal emitted by the sample. Furthermore, the peripheral components comprise a power supply unit 306, for example in the form of a power supply unit, which in particular provides alternating voltage, and a temperature control unit 307, which is configured to set a temperature in the test module unit, in particular by heating and/or cooling.

Furthermore, a mechanical unit 308 is also included in the peripheral components, which, among other things, enables a cartridge 309 to be received (for example, a clamping device for the cartridge 309), wherein the sample is placed into the cartridge 309. The test module unit 301 is thereby configured for sample collection. Furthermore, the mechanical unit 308 enables mechanical processing of the sample, such as sample rotation or centrifugation.

The microfluidic analysis system 300 may be operated as follows: The sample, in particular a liquid sample, is processed within the test module 3001 either semi-automatically or fully automatically by inserting the cartridge 309 into the microfluidic analysis system 300. The partially or fully automated processing of the sample can be carried out in particular by applying different pressure levels (of the first and/or second target pressure level 1051, 1052) to the test module 3001 via a suitable interface between the pressure supply unit 100 and the test module 3001.

First, the sample is placed in the cartridge 309. In particular, the sample is at least partially in liquid form, wherein the sample may comprise, in particular, a biological or medical substance, such as a bodily fluid (e.g., blood, saliva, etc.).

The cartridge 309 containing the sample is inserted or placed in the test module 3001 and connected to it via the interfaces required to process the sample in the cartridge 309.

The sample can now be processed in the test module 3001. The following steps may be included in the processing, depending on the selected procedure: purification, lysis and thermal cycling of liquids, such as PCR procedures for the detection of specific virus strains, etc.

After processing, the cartridge 309 may be removed from the test module and an analysis result of the sample may be output by the microfluidic analysis system, for example via an optical display, and/or transmitted via a communication interface to another device, such as a printer or a mobile terminal.

The pressure supply unit 100 is connected or connectable to the test module unit 301 via the interface 302.

The microfluidic elements 302, 303, 304 of the test module unit 3000 can be controlled by means of the first target pressure level 1051 and/or the second target pressure level 1052. In this exemplary embodiment, the microfluidic elements comprise a pneumatic manifold 303 for distributing and controlling valves, and pressure tanks 304 (i.e., pneumatic tanks 1021, 1022) for providing a minimum amount of compressed air as a reservoir, and an external interface 302. Alternatively or in addition, the pressure supply unit 100 may comprise the pneumatic tanks 1021, 1022.

FIG. 5 shows a schematic sketch of a microfluidic analysis system 300, which forms a small parallel system 300′, wherein the test module unit 301 comprises three test modules 3001, 3002, 3003. The test modules are structured in the same way as the test module in FIG. 4. Each of the test modules 3001, 3002, 3003 is connected or connectable to the pressure supply unit 100 via its pneumatic interface 302. Thus, each of the test modules is supplied with the first target pressure level 1051 and the second target pressure level 1052 in parallel with the other test modules.

FIG. 6 shows a schematic sketch of a microfluidic analysis system 300, which forms a large parallel system 300″, wherein the test module unit 301 comprises nine test modules 3001, 3002, 3003. The nine test modules are divided into three test module units, 301, each comprising three test modules, 3001, 3002, 3003. The pressure supply unit 100 supplies the three small parallel systems 300′, which are designed in this exemplary embodiment in the same way as the small parallel systems 300′ shown in FIG. 5, with the first target pressure level 1051 and the second target pressure level 1052 respectively.

1. A pressure supply unit for providing a first target pressure level and a second target pressure level for a microfluidic analysis system, comprising:
a pump configured to draw in a fluid;
a first fluid flow control component arranged on a first side of the pressure supply unit relative to the pump and configured to enable fluid flow (i) from the first side of the pressure supply unit to the pump when a first current pressure level on the first side is greater than the first target pressure level, and (ii) from surrounding area of the pressure supply unit to the pump when the first current pressure level is less than or equal to the first target pressure level such that the first fluid flow control component provides the first target pressure level on the first side of the pressure supply unit; and
a second fluid flow control component arranged on a second side of the pump and configured to enable fluid flow (i) from the pump to a second side of the pressure supply unit, when a second current pressure level on the second side is lower than the second target pressure level and (ii) from the pump to the surrounding area of the pressure supply unit, provided that when a second current pressure level on the second side is greater than or equal to the second target pressure level such that the second fluid flow control component provides the second target pressure level on the second side of the pressure supply unit,
wherein the first target pressure level and the second target pressure level differ from one another.

2. The pressure supply unit according to claim 1, wherein the first fluid flow control component is connected to a first storage volume and/or the second fluid flow control component is connected to a second storage volume.

3. The pressure supply unit according to claim 1, wherein the first target pressure level and the second target pressure level each have a value of greater than or equal to 200 mbarA and less than or equal to 3000 mbarA system pressure.

4. The pressure supply unit according to claim 1, further comprising a pressure sensor unit arranged on at least one of the first and second sides and configured for pressure control and/or for controlling a safety shutdown.

5. The pressure supply unit according to claim 1, wherein the first fluid flow control component and the second fluid flow control component are dimensioned such that a pressure loss across the first and second fluid flow control components is less than or equal to 5% of a system pressure.

6. The pressure supply unit according to claim 1, wherein at least one of the first fluid flow control component and the second fluid flow control component includes a switching valve.

7. The pressure supply unit according to claim 1, wherein at least one of the first fluid flow control component and the second fluid flow control component includes a check valve.

8. A method for providing a first target pressure level and a second target pressure level, which differ from one another, with the pressure supply unit according to claim 1, the method comprising:
providing the first target pressure level on the first side of the pressure supply unit by enabling a fluid flow (i) from the first side of the pressure supply unit to the pump when the first current pressure level on the first side is greater than the first target pressure level, and (ii) from the surrounding area of the pressure supply unit to the pump when the first current pressure level on the first side is less than or equal to the first target pressure level; and
providing the second target pressure level on the second side of the pressure supply unit by transferring the fluid (i) from the pump to the second side of the pressure supply unit when the second current pressure level on the second side is less than the second target pressure level, and (ii) from the pump to the surrounding area of the pressure supply unit when the second current pressure level on the second side is greater than or equal to the second target pressure level.

9. The method according to claim 8, further comprising:
when the first target pressure level is reached at the first side and the second target pressure level is reached at the second side, switching off the pump of the pressure supply unit or continuing operation of the pump such that the fluid is drawn-in from the surrounding area and transferred to the surrounding area via the pump.

10. A microfluidic analysis system for performing sample analysis comprising:
at least one test module unit for sample collection for molecular diagnostic analysis, each of the at least one test module unit comprises one or more test modules;
a pressure supply unit according to claim 1 for providing the first target pressure level and the second target pressure level,
peripheral components configured to perform a molecular diagnostic analysis; and
microfluidic elements for sample transport in the at least one test module unit, the microfluidic elements being controlled by at least one of the first target pressure level and the second target pressure level,
wherein the pressure supply unit is connected or connectable to the at least one test module unit via an interface.

11. The microfluidic analysis system according to claim 10, wherein the at least one test module unit includes two or more test module units controlled in parallel by the pressure supply unit.

12. A control unit configured to execute the method according to claim 8 in corresponding units and/or to control them.

13. A computer program comprising control instruction that, when executed by a control unit, cause the control unit to carry out and/or control the method according to claim 8.

14. A machine-readable storage medium comprising the computer program according to claim 13.

15. The pressure supply unit according to claim 2, wherein the first storage volume and/or the second storage volume are stored in respective fluid tanks.

16. The pressure supply unit according to claim 6, wherein the switching valve is a 3/2-way valve.
